(19) United States
(12) Patent Application Publication
(10) Pub. No.: US 2025/0222510 A1
(43) Pub. Date: Jul. 10, 2025

(54) FORMING SYSTEM

(71) Applicant: SUMITOMO HEAVY INDUSTRIES, LTD., Tokyo (JP)

(72) Inventors: Noboru ITAGAKI, Niihama-shi (JP); Norieda UENO, Niihama-shi (JP)

(21) Appl. No.: 19/089,680

(22) Filed: Mar. 25, 2025

Related U.S. Application Data
(63) Continuation of application No. PCT/JP2023/035619, filed on Sep. 29, 2023.

(30) Foreign Application Priority Data
Dec. 5, 2022 (JP) 2022-194265

(51) Int. Cl. B21D 43/08

(52) U.S. Cl. CPC B21D 43/08

(57) ABSTRACT

A forming system is a forming system that heats a metal material, the forming system including: an energization heating section that energizes and heats the metal material; a processing section that processes the heated metal material; and a roller transport section that transports the heated metal material between the energization heating section and the processing section, in which rollers of the roller transport section are disposed from the energization heating section to an inside of the processing section.

### CROSS-REFERENCE TO RELATED APPLICATIONS

This is a bypass continuation of International PCT Application No. PCT/JP2023/035619, filed on Sep. 29, 2023, which claims priority to Japanese Patent Application No. 2022-194265, filed on Dec. 5, 2022, which are incorporated by reference herein in their entirety.

### BACKGROUND

### Technical Field

A certain embodiment of the present disclosure relates to a forming system.

### Description of Related Art

In the related art, as an apparatus for processing a heated metal material, an apparatus described in the related art is known. This processing apparatus is a forming apparatus. The forming apparatus can perform quenching at the same time as forming by bringing a heated metal pipe material into contact with a forming die.

### SUMMARY

According to an aspect of the present disclosure, there is provided a forming system that heats a metal material, the forming system including: an energization heating section that energizes and heats the metal material; a processing section that processes the heated metal material; and a roller transport section that transports the heated metal material between the energization heating section and the processing section, in which rollers of the roller transport section are disposed from the energization heating section to an inside of the processing section.

### BRIEF DESCRIPTION OF THE DRAWINGS

FIG. 1 is a schematic configuration diagram showing a configuration of a forming system according to the present embodiment.

FIG. 2 is a schematic configuration diagram showing the configuration of the forming system according to the present embodiment.

FIGS. 3A to 3C are schematic diagrams showing an operation of the forming system.

FIGS. 4A to 4C are schematic diagrams showing the operation of the forming system.

FIG. 5 is a schematic configuration diagram showing a configuration of a forming system according to a modification example.

FIG. 6 is a schematic configuration diagram showing the configuration of the forming system according to the modification example.

### DETAILED DESCRIPTION

In the processing apparatus described in the related art described above, energization heating is performed using an electrode in the forming apparatus. There is a case where an energization heating section is disposed outside the processing apparatus. In this case, after a metal material is heated by an external energization heating section, the metal material is transported to the processing apparatus by a robot arm or the like. However, in this method, there is an issue in that a time for chucking the metal material or a three-dimensional transport locus is required, the transport takes time, and the temperature of the metal material decreases. On the other hand, there is an issue in that a high-speed robot arm is expensive and it still takes time for chucking.

According to an embodiment of the present disclosure, it is desirable to provide a forming system in which it is possible to quickly transport an energized and heated metal material to a processing section.

The forming system includes the energization heating section that energizes and heats a metal material, and the processing section that processes the heated metal material. Therefore, the metal material that is energized and heated by the energization heating section is processed in the processing section. Here, the forming system includes the roller transport section that transports the heated metal material between the energization heating section and the processing section. Therefore, the roller transport section can quickly transport the metal material energized and heated in the energization heating section toward the processing section by using a plurality of rollers without performing chucking or the like. Accordingly, the energized and heated metal material can be quickly transported to the processing section.

The roller transport section may transport the heated metal material while maintaining a posture of the metal material when the processing is performed in the processing section. In this case, the processing section can quickly perform the processing without performing a direction change or the like of the transported metal member.

In a case where a reference axis of the metal material when the metal material is installed in the processing section is set, the roller transport section may transport the metal material in parallel with the reference axis at a position deviated from the reference axis. In this case, the roller transport section can transport the heated metal material while maintaining the posture of the metal material when the processing in the processing section is performed. Therefore, the processing section can quickly perform the processing without performing a direction change or the like of the transported metal member by being parallel-moved by an amount corresponding to the deviation from the reference axis.

The processing section may be a forming apparatus that forms the metal material by pressing. In this case, the forming apparatus can quickly form the energized and heated metal material in a state where a temperature decrease is suppressed.

The processing section may be a high-temperature heating section that heats the metal material to a temperature higher than a heating temperature in the energization heating section. In this case, the high-temperature heating section can quickly heat the energized and heated metal material to a higher temperature in a state where a temperature decrease is suppressed.

The forming system may further include a transfer section that transfers the metal material heated in the energization heating section to the roller transport section. In this case, the transfer section can quickly transfer the energized and heated metal material to the roller transport section.

Hereinafter, a preferred embodiment of the present disclosure will be described with reference to the drawings. In each drawing, identical or corresponding portions are denoted by the same reference numerals, and overlapping description is omitted.

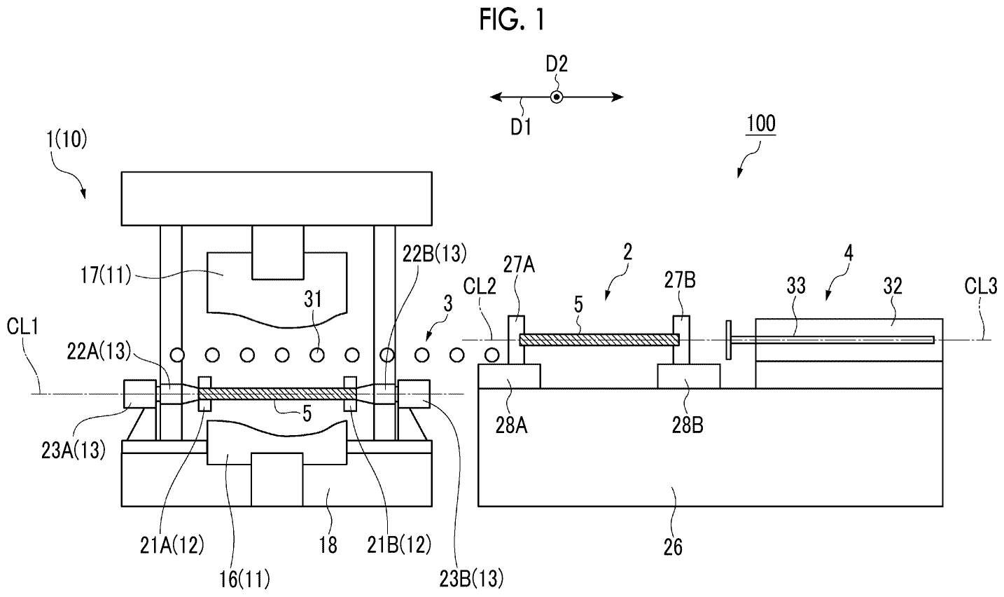

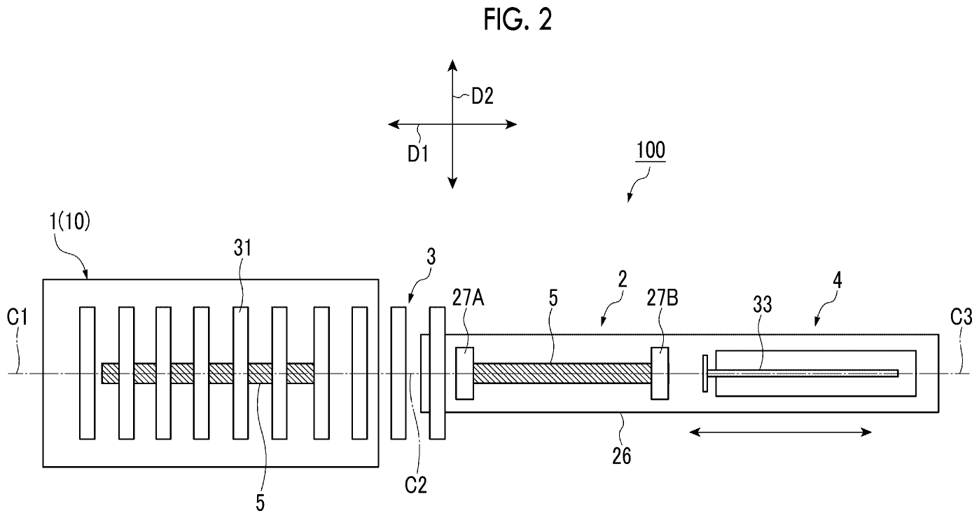

FIGS. 1 and 2 are schematic configuration diagrams showing a configuration of a forming system 100 according to the present embodiment. The forming system 100 is a system that forms a metal material. The forming system 100 is also capable of functioning as a heating system that heats a metal material. As shown in FIGS. 1 and 2, the forming system 100 includes a processing section 1, an energization heating section 2, a roller transport section 3, and a transfer section 4. In the present embodiment, a metal pipe material 5 is used as the metal material.

The processing section 1 is an apparatus that processes the heated metal pipe material 5. In the present embodiment, as the processing section 1, a forming apparatus 10 that forms the heated metal pipe material 5 by pressing is adopted. The forming apparatus 10 is an apparatus that forms the heated metal pipe material 5 with a forming die 11. In the present embodiment, as the forming apparatus 10, a forming apparatus that forms and quenches a metal pipe having a hollow shape by supplying a fluid to the heated metal pipe material 5 to bring the heated metal pipe material 5 into contact with a forming surface of the forming die 11 is adopted.

As shown in FIG. 1, in the present embodiment, the forming apparatus 10 is installed on a horizontal surface. The forming apparatus 10 includes the forming die 11, a holding unit 12, and a fluid supply unit 13. In the present specification, the metal pipe material 5 refers to a hollow article before the completion of the forming in the forming apparatus 10. The metal pipe material 5 is a steel-type pipe material that can be quenched. In addition, a reference axis CL1 of the metal pipe material 5 when the metal pipe material 5 is installed in the forming apparatus 10 is set. A direction in which the reference axis CL1 extends may be referred to as an “axial direction D1”. In addition, in the horizontal direction, a direction perpendicular to the axial direction D1 may be referred to as a “width direction D2”.

The forming die 11 is a die that forms a metal pipe from the metal pipe material 5, and includes a lower die 16 and an upper die 17 that face each other in an up-down direction. The lower die 16 and the upper die 17 are configured with blocks made of steel. Each of the lower die 16 and the upper die 17 is provided with a recessed part in which the metal pipe material 5 is accommodated. In a state where the lower die 16 and the upper die 17 are in close contact with each other (a die closed state), the respective recessed parts form a space having a target shape in which the metal pipe material 5 is to be formed. Therefore, the surfaces of the respective recessed parts serve as a forming surface of the forming die 11. The lower die 16 is fixed to a base stage 18 via a die holder or the like. The upper die 17 is fixed to a slide of a drive mechanism via a die holder or the like. The drive mechanism is a mechanism that moves at least one of the lower die 16 and the upper die 17. A cooling mechanism for cooling each of the dies 16 and 17 is provided inside each of the dies 16 and 17.

The holding unit 12 is a mechanism that holds the metal pipe material 5 disposed between the lower die 16 and the upper die 17. The holding unit 12 includes a retaining member 21A that holds the metal pipe material 5 on one end side in the axial direction D1 of the forming die 11, and a retaining member 21B that holds the metal pipe material 5 on the other end side in the axial direction D1 of the forming die 11. Each of the retaining members 21A and 21B on both sides in the axial direction D1 is divided into an upper member and a lower member, and holds the metal pipe material 5 by pinching the vicinity of the end portion of the metal pipe material 5 in the up-down direction. Each of the retaining members 21A and 21B is provided with a drive mechanism (not shown) and is movable in the up-down direction. The retaining member does not need to be divided into an upper side and a lower side, and may be divided into, for example, a left side and a right side.

The fluid supply unit 13 is a mechanism for supplying a high-pressure fluid into the metal pipe material 5 held between the lower die 16 and the upper die 17. The fluid supply unit 13 supplies a high-pressure fluid to the metal pipe material 5 in a high-temperature state to expand the metal pipe material 5. The fluid supply units 13 are provided on both end sides of the forming die 11 in the axial direction D1. The fluid supply unit 13 includes nozzles 22A and 22B, each of which supplies a fluid from an opening portion of an end portion of the metal pipe material 5 to the inside of the metal pipe material 5, and drive mechanisms 23A and 23B that move the nozzles 22A and 22B forward and rearward with respect to the opening portion of the metal pipe material 5. The fluid supply unit 13 may supply a gas such as high-pressure air or an inert gas, as the fluid. Additionally, the fluid supply unit 13 may be made to be the same device together with the holding unit 12 having a mechanism that moves the metal pipe material 5 in the up-down direction.

The energization heating section 2 is a device that energizes and heats the metal pipe material 5. The energization heating section 2 heats the metal pipe material 5 by energizing the metal pipe material 5. The energization heating section 2 is disposed to be adjacent to the forming apparatus 10 at a position separated from the forming apparatus 10 in the axial direction D1. The energization heating section 2 is provided on a base portion 26. The energization heating section 2 includes electrodes 27A and 27B disposed to be separated from each other in the axial direction D1. Each of the electrodes 27A and 27B is divided into an upper member and a lower member, and holds the metal pipe material 5 by pinching the vicinity of the end portion of the metal pipe material 5 in the up-down direction. The electrodes 27A and 27B are supported by pedestal portions 28A and 28B provided on the base portion 26. The energization heating section 2 causes an electric current to flow through the metal pipe material 5 from a power source (not shown) via the electrodes 27A and 27B in a state where the metal pipe material 5 is held by the electrodes 27A and 27B. Each of the electrodes 27A and 27B is provided with a drive mechanism (not shown), and the divided member is movable in the up-down direction. Each of the electrodes 27A and 27B does not need to be divided into upper and lower portions, and may be divided into left and right portions.

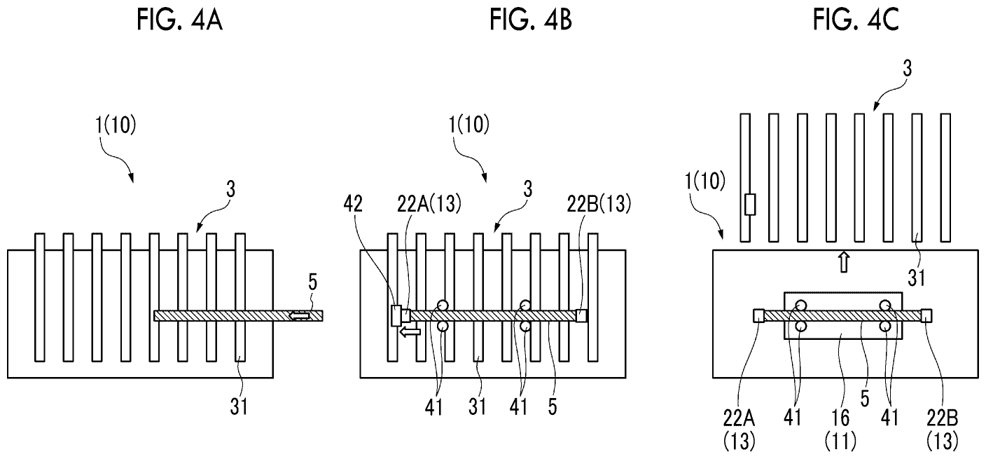

The roller transport section 3 transports the heated metal pipe material 5 between the energization heating section 2 and the forming apparatus 10. The roller transport section 3 includes a plurality of rollers 31 extending in parallel with the width direction D2 (refer to FIG. 2). The plurality of rollers 31 are disposed in a state of being spaced apart from each other at equal intervals in the axial direction D1. The height position of the upper end of each of the plurality of rollers 31 is set to be the same position as the lower end of the metal pipe material 5 in a state of being held by the electrodes 27A and 27B of the energization heating section 2. Accordingly, the metal pipe material 5 is smoothly transferred from the energization heating section 2 to the roller transport section 3. The plurality of rollers 31 are disposed from the position adjacent to the electrode 27A on the forming apparatus 10 side to the position of the retaining member 21A of the forming apparatus 10. The roller transport section 3 includes a drive unit that rotates each roller 31. The plurality of rollers 31 are disposed between the dies 16 and 17 when the metal pipe material 5 is being transported. In contrast, the roller transport section 3 includes a mechanism for moving the plurality of rollers 31 in the width direction D2 to retreat the rollers 31 from the dies 16 and 17 (refer to FIG. 4C).

The transfer section 4 is a device that transfers the metal pipe material 5 heated in the energization heating section 2 to the roller transport section 3. The transfer section 4 is disposed at a position adjacent to the energization heating section 2 in the axial direction D1 on the base portion 26. The transfer section 4 is disposed on a side opposite to the forming apparatus 10 and the roller transport section 3 with respect to the energization heating section 2. The transfer section 4 includes a main body 32 disposed on the base portion 26 and an extrusion portion 33. The extrusion portion 33 is supported by the main body 32 to be movable back and forth in the axial direction. The extrusion portion 33 extrudes the metal pipe material 5 disposed in the energization heating section 2 to the roller transport section 3.

The position of the metal pipe material 5 at each location will be described. A reference axis CL2 of the metal pipe material 5 in a state of being held by the electrodes 27A and 27B is parallel to the axial direction D1. In a front view shown in FIG. 1, the reference axis CL2 is disposed above the reference axis CL1 in the forming apparatus 10. The center line of the metal pipe material 5 when being transported by the roller transport section 3 is parallel to the reference axis CL1 at a position deviated upward from the reference axis CL1. In a plan view shown in FIG. 2, the reference axis CL1 and the reference axis CL2 are parallel to and coincide with each other. In a plan view shown in FIG. 2, the center line of the metal pipe material 5 when the metal pipe material 5 is being transported by the roller transport section 3 is parallel to and coincides with the reference axis CL1. A reference axis CL3 of the extrusion portion 33 of the transfer section 4 coincides with the reference axis CL2 of the energization heating section 2. The fact that the reference axes coincide with each other means that the reference axes do not need to completely coincide with each other, and the reference axes may be slightly deviated from each other (do not need to completely coincide with each other) as long as the task in the present application can be solved.

Next, an operation of the forming system 100 will be described. First, the metal pipe material 5 is held by the electrodes 27A and 27B of the energization heating section 2. The metal pipe material 5 is disposed at the energization heating section 2 with a robot arm (not shown), a transport device (not shown), or manually by a worker. Next, the energization heating section 2 energizes and heats the metal pipe material 5 via the electrodes 27A and 27B. In this way, an electric current in the axial direction D1 flows through the metal pipe material 5, and the metal pipe material 5 itself generates heat due to Joule heat by an electric resistance of the metal pipe material 5 itself. After the heating, the holding by the electrodes 27A and 27B is released.

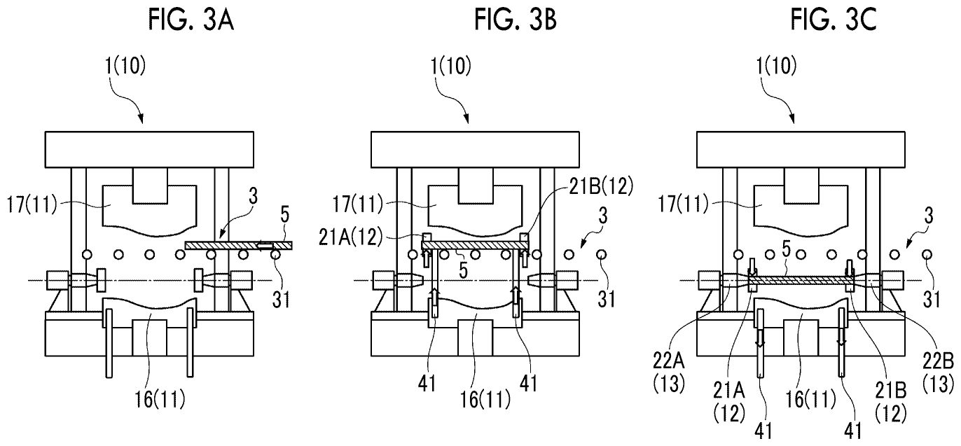

The transfer section 4 transfers the metal pipe material 5 in the energization heating section 2 to the roller transport section 3 by extruding the metal pipe material 5 with the extrusion portion 33. In this way, as shown in FIGS. 3A and 4A, the metal pipe material 5 is transported to the forming apparatus 10 by the roller transport section 3. When the metal pipe material 5 reaches the positions of the dies 16 and 17, as shown in FIGS. 3B and 4B, a positioning member 41 extends from the lower side toward the metal pipe material 5. The positioning member 41 extends to the upper side of the roller 31 and restricts movement of the metal pipe material 5 in the width direction (refer to FIG. 4B). In this state, the retaining members 21A and 21B move upward to hold the metal pipe material 5 on the roller transport section 3. The metal pipe material 5 is restricted from moving in the transport direction by a regulating member 42 (refer to FIG. 4B).

Next, as shown in FIGS. 3C and 4C, the rollers 31 of the roller transport section 3 retreat from the positions of the dies 16 and 17. In addition, the positioning members 41 and the retaining members 21A and 21B move downward together with the metal pipe material 5. In this way, the metal pipe material 5 is in a state of being held by the retaining members 21A and 21B at the forming position.

The forming apparatus 10 lowers the upper die 17 to bring the upper die 17 close to the lower die 16, and closes the forming die 11. On the other hand, the fluid supply unit 13 seals the opening portions at both ends of the metal pipe material 5 with the nozzles 22A and 22B and supplies a fluid. In this way, the metal pipe material 5 softened by the heating expands and comes into contact with the forming surface of the forming die 11. Then, the metal pipe material 5 is formed to follow the shape of the forming surface of the forming die 11. In a case where a metal pipe with a flange is formed, a part of the metal pipe material 5 is made to enter the gap between the lower die 16 and the upper die 17, and then die closing is further performed to crush the entered part to form a flange portion. When the metal pipe material 5 comes into contact with the forming surface, the metal pipe material 5 is quenched by being rapidly cooled by the cooled forming die 11.

Next, the operation and effects of the forming system 100 according to the present embodiment will be described.

The forming system 100 includes the energization heating section 2 that energizes and heats the metal pipe material 5, and the processing section 1 that processes the heated metal pipe material 5. Therefore, the metal pipe material 5 energized and heated in the energization heating section 2 is processed in the processing section 1. Here, the forming system 100 includes the roller transport section 3 that transports the heated metal pipe material 5 between the energization heating section 2 and the processing section 1. Therefore, the roller transport section 3 can quickly transport the metal pipe material 5 energized and heated in the energization heating section 2 toward the processing section 1 by using the plurality of rollers 31 without performing chucking. Accordingly, the energized and heated metal pipe material 5 can be quickly transported to the processing section 1.

The roller transport section 3 may transport the heated metal pipe material 5 while maintaining the posture of the metal pipe material 5 when the processing in the processing section 1 is performed. In this case, the processing section 1 can quickly perform the processing without performing a direction change or the like of the transported metal pipe material 5. In the embodiment, in a case where the reference axis CL1 of the metal pipe material 5 when the metal pipe material 5 is installed in the processing section 1 is set, the roller transport section 3 transports the metal pipe material 5 in the axial direction D1 in which the reference axis CL1 extends.

In a case where the reference axis CL1 of the metal pipe material 5 when the metal pipe material 5 is installed in the processing section 1 is set, the roller transport section 3 may transport the metal pipe material 5 in parallel with the reference axis CL1 at a position deviated from the reference axis CL1. In this case, the roller transport section 3 can transport the heated metal pipe material 5 while maintaining the posture of the metal pipe material 5 when the processing in the processing section 1 is performed. Therefore, the processing section 1 can quickly perform the processing without performing a direction change or the like of the transported metal pipe material 5 by being parallel-moved by an amount corresponding to the deviation from the reference axis CL1. In the present embodiment, in a front view, the roller transport section 3 transports the metal pipe material 5 in parallel with the reference axis CL1 at a position deviated upward from the reference axis CL1. Therefore, the metal pipe material 5 can be disposed at the forming position of the forming apparatus 10 by lowering the metal pipe material 5 from the roller transport section 3 in a state of being parallel to the reference axis CL1. In a plan view, since the roller transport section 3 can transport the metal pipe material 5 on the reference axis CL1, the metal pipe material 5 can be disposed at the forming position of the forming apparatus 10 without parallel movement for eliminating the deviation.

The processing section 1 may be the forming apparatus 10 that forms the metal pipe material 5 by pressing. In this case, the forming apparatus 10 can quickly form the energized and heated metal pipe material 5 in a state where a temperature decrease is suppressed.

The forming system 100 may further include the transfer section 4 that transfers the metal pipe material 5 heated in the energization heating section 2 to the roller transport section 3. In this case, the transfer section 4 can quickly transfer the energized and heated metal pipe material 5 to the roller transport section 3.

The present disclosure is not limited to the embodiment described above.

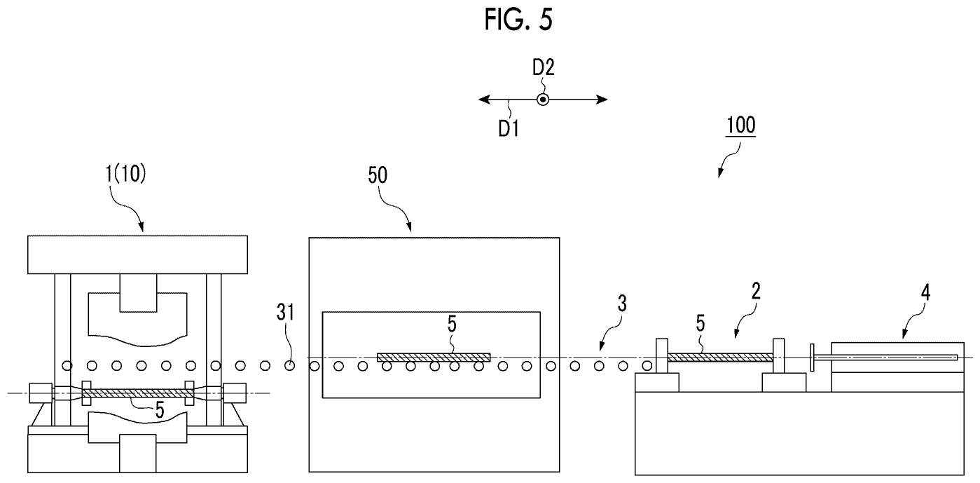

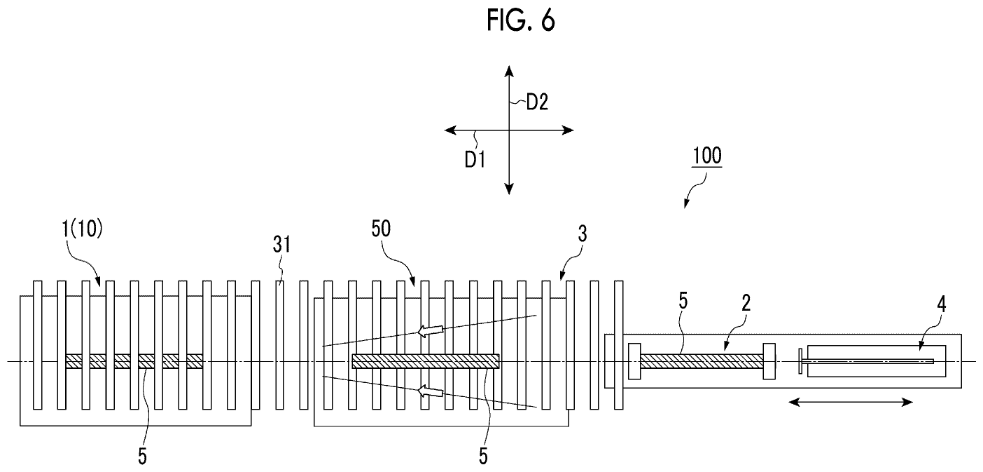

In the embodiment described above, the forming apparatus 10 has been adopted as the processing section 1. Alternatively, or in addition to this, another apparatus may be adopted. For example, as shown in FIGS. 5 and 6, the processing section 1 may be a high-temperature heating section 50 that heats the metal pipe material 5 to a temperature higher than a heating temperature in the energization heating section 2. In this case, the high-temperature heating section 50 can quickly heat the energized and heated metal material to a higher temperature in a state where a temperature decrease is suppressed.

The high-temperature heating section 50 is disposed between the energization heating section 2 and the forming apparatus 10. The roller transport section 3 transports the metal pipe material 5 from the energization heating section 2 to the high-temperature heating section 50. When the heating in the high-temperature heating section 50 is completed, the roller transport section 3 transports the metal pipe material 5 to the forming apparatus 10. For example, the energization heating section 2 heats the metal pipe material 5 from 20° C. to 600° C. The high-temperature heating section 50 heats the metal pipe material 5 from 600° C. to 1000° C.

In the embodiment described above, the transfer section 4 transfers the metal pipe material 5 to the roller transport section 3 by extruding the metal pipe material 5. However, the metal pipe material 5 may be transferred to the roller transport section 3 by using a jig for pulling the metal pipe material 5 from the energization heating section 2.

In the embodiment described above, the center line of the metal pipe material 5 that is transported in the roller transport section 3 and the reference axis CL2 of the energization heating section 2 are deviated upward from the reference axis CL1 of the forming apparatus 10. However, the center line of the metal pipe material 5 that is transported in the roller transport section 3 and the reference axis CL2 of the energization heating section 2 may be completely disposed on the reference axis CL1.

A direction in which the roller transport section 3 transports the metal pipe material 5 to the processing section 1 is not particularly limited, and the metal pipe material 5 may be transported in the width direction D2.

The metal material is not limited to the metal pipe material, and may be a metal plate material. In that case, a forming apparatus that is not provided with the fluid supply unit is adopted.

### Form 1

A forming system that heats a metal material, the forming system including:
an energization heating section that energizes and heats the metal material;
a processing section that processes the heated metal material; and
a roller transport section that transports the heated metal material between the energization heating section and the processing section.

### Form 2

The forming system according to Form 1, in which the roller transport section transports the heated metal material while maintaining a posture of the metal material when the processing is performed in the processing section.

### Form 3

The forming system according to Form 1 or 2, in which in a case where a reference axis of the metal material when the metal material is installed in the processing section is set,
the roller transport section transports the metal material in parallel with the reference axis at a position deviated from the reference axis.

### Form 4

The forming system according to any one of Forms 1 to 3, in which the processing section is a forming apparatus that forms the metal material by pressing.

### Form 5

The forming system according to any one of Forms 1 to 4, in which the processing section is a high-temperature heating section that heats the metal material to a temperature higher than a heating temperature in the energization heating section.

### Form 6

The forming system according to any one of Forms 1 to 5, further including:
a transfer section that transfers the metal material heated in the energization heating section to the roller transport section.

It should be understood that the invention is not limited to the above-described embodiment, but may be modified into various forms on the basis of the spirit of the invention. Additionally, the modifications are included in the scope of the invention.

What is claimed is:

1. A forming system that forms a metal material, the forming system comprising:
an energization heating section that energizes and heats the metal material;
a processing section that processes the heated metal material; and
a roller transport section that transports the heated metal material between the energization heating section and the processing section,
wherein rollers of the roller transport section are disposed from the energization heating section to an inside of the processing section.

2. The forming system according to claim 1, wherein the roller transport section transports the heated metal material while
maintaining a posture of the metal material when the processing is performed in the processing section.

3. The forming system according to claim 2,
wherein the processing section includes a fluid supply unit that supplies a high-pressure fluid to the metal material in a high-temperature state to expand the metal material.

4. The forming system according to claim 1,
wherein the energization heating section includes electrodes disposed to be separated from each other in an axial direction.

5. The forming system according to claim 4,
wherein the roller transport section includes a plurality of rollers, and a height position of an upper end of each of the plurality of rollers is set to be the same position as a lower end of the metal material in a state of being held by the electrodes of the energization heating section.

6. The forming system according to claim 1,
wherein in a case where a reference axis of the metal material when the metal material is installed in the processing section is set,
the roller transport section transports the metal material in parallel with the reference axis at a position deviated from the reference axis.

7. The forming system according to claim 1,
wherein the processing section is a forming apparatus that forms the metal material by pressing.

8. The forming system according to claim 1,
wherein the processing section is a high-temperature heating section that heats the metal material to a temperature higher than a heating temperature in the energization heating section.

9. The forming system according to claim 1, further comprising:
a transfer section that transfers the metal material heated in the energization heating section to the roller transport section.

10. The forming system according to claim 9,
wherein the transfer section includes a main body and an extrusion portion that is supported by the main body to be movable back and forth in an axial direction and extrudes the metal material disposed in the energization heating section to the roller transport section.

11. The forming system according to claim 10,
wherein a center line of the metal material when being transported by the roller transport section is parallel to and coincides with a reference axis of the metal material when the metal material is installed in the processing section, and a reference axis of the extrusion portion of the transfer section coincides with a reference axis of the energization heating section.

12. The forming system according to claim 1, further comprising:
a positioning portion for restricting movement of a metal pipe material in a width direction when the metal pipe material reaches predetermined positions of dies.

13. The forming system according to claim 12,
wherein, after the movement of the metal pipe material is restricted by the positioning portion, the rollers of the roller transport section retreat from the dies.
